(19) United States
(12) Patent Application Publication
(10) Pub. No.: US 2017/0074492 A1
(43) Pub. Date: Mar. 16, 2017

(54) Fixing Structure for Lamp Holder

(71) Applicant: DONGGUAN LIGUANG LIGHTING INDUSTRIES CO., LTD., Dongguan City (CN)

(72) Inventor: Chin-Sung Tsai, Dongguan City (CN)

(21) Appl. No.: 14/851,073

(22) Filed: Sep. 11, 2015

(51) Int. Cl. F21V 17/06; F21V 17/16; F21V 1/00

(52) U.S. Cl. CPC F21V 17/06; F21V 1/00; F21V 17/164

(57) ABSTRACT

A fixing structure for a lamp holder contains: a locking mount, a retaining seat, and a lampshade. The locking mount includes a conical tab extending outwardly from a bottom thereof, and the conical tab has inner threads for screwing with a bulb. The retaining seat includes a positioning ring, a plurality of retainers arranged around the positioning ring, and two oppositely flexible clampers extending outwardly from the positioning ring. The lampshade includes a top face for retaining with the two oppositely flexible clampers. Accordingly, the conical tab is fixed in the positioning ring and is retained by the plurality of retainers, and the retaining seat is placed into the lampshade from the top face so that its two oppositely flexible clampers clamp the locking mount and retain with the top face, thereafter the bulb is screwed with the locking mount, thus connecting the locking mount with the lampshade easily.

### FIELD OF THE INVENTION

The present invention relates to a fixing structure for a lamp holder which is simplified and is operated easily.

### BACKGROUND OF THE INVENTION

With reference to FIG. 1, a conventional fixer A2 for a lamp holder contains a positioning ring A21 and two oppositely flexible clampers A22 arranged on the positioning ring A21; a locking mount A formed in a cone shape, wherein a diameter of an upper end of the locking mount A is smaller than that of a lower end of the locking mount A, and the locking mount A has a retaining tab Al extending outwardly from a bottom thereof. Thereby, the positioning ring A21 of the fixer A2 is fitted with the locking mount A and retains with the retaining tab A1. However, the fixer A2 removes from the retaining tab Al easily as thermal expansion and contraction occurs.

The present invention has arisen to mitigate and/or obviate the afore-described disadvantages.

### SUMMARY OF THE INVENTION

The primary objective of the present invention is to provide a fixing structure for a lamp holder which connects a locking mount with a lampshade easily and removes the locking mount from the lampshade quickly.

Further objective of the present invention is to provide a fixing structure for a lamp holder which a reinforcement extension retains with the lampshade securely, when a retaining seat is placed into the lampshade.

Another objective of the present invention is to provide a fixing structure for a lamp holder in which a conical tab of the locking mount is placed into an engaging rib of the lampshade and is retained by a plurality of affix protrusions easily.

To obtain above-mentioned objectives, a fixing structure for a lamp holder provided by the present invention contains: a locking mount, a retaining seat, and a lampshade.

The locking mount includes a conical tab extending outwardly from a bottom thereof.

The retaining seat includes a positioning ring, a plurality of retainers arranged around the positioning ring, and two oppositely flexible clampers extending outwardly from the positioning ring.

The lampshade includes a top face for retaining with the two oppositely flexible clampers.

### BRIEF DESCRIPTION OF THE DRAWINGS

FIG. 1 is a perspective view showing the exploded components of a conventional fixer for a lamp holder.

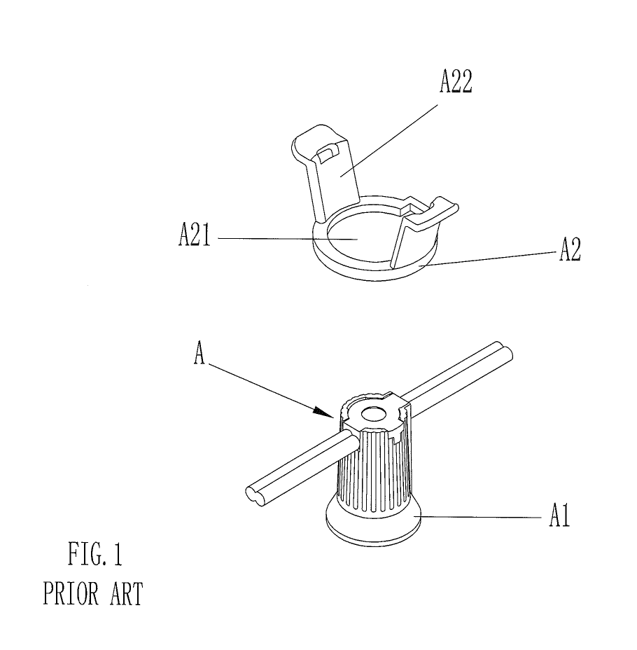

FIG. 2 is a perspective view showing the assembly of a fixing structure for a lamp holder according to a preferred embodiment of the present invention.

FIG. 3 is a perspective view showing the exploded components of the fixing structure for the lamp holder according to the preferred embodiment of the present invention.

FIG. 4 is a cross sectional view showing the exploded components of the fixing structure for the lamp holder according to the preferred embodiment of the present invention.

FIG. 5 is a cross sectional view showing the assembly of the fixing structure for the lamp holder according to the preferred embodiment of the present invention.

FIG. 6 is a cross sectional view showing the operation of the fixing structure for the lamp holder according to the preferred embodiment of the present invention.

FIG. 7 is a perspective view showing the exploded components of a fixing structure for a lamp holder according to another preferred embodiment of the present invention.

### DETAILED DESCRIPTION OF THE PREFERRED EMBODIMENTS

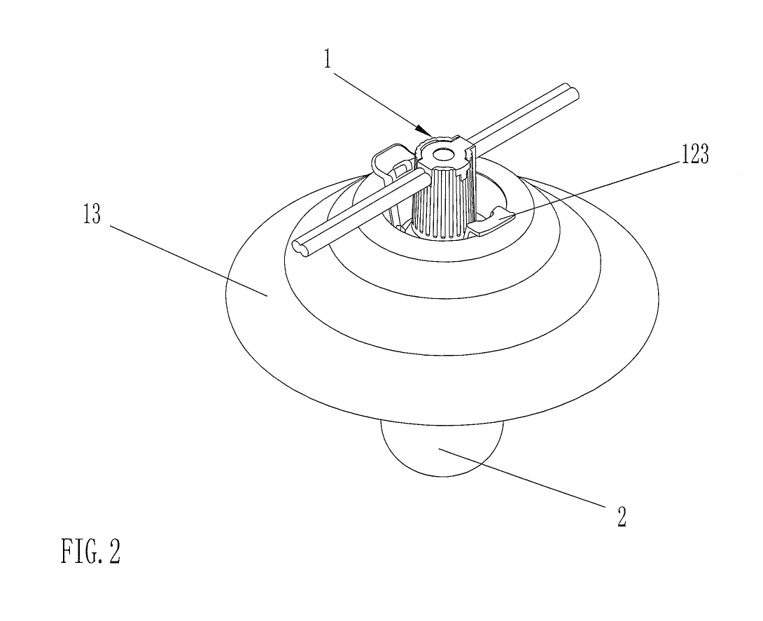

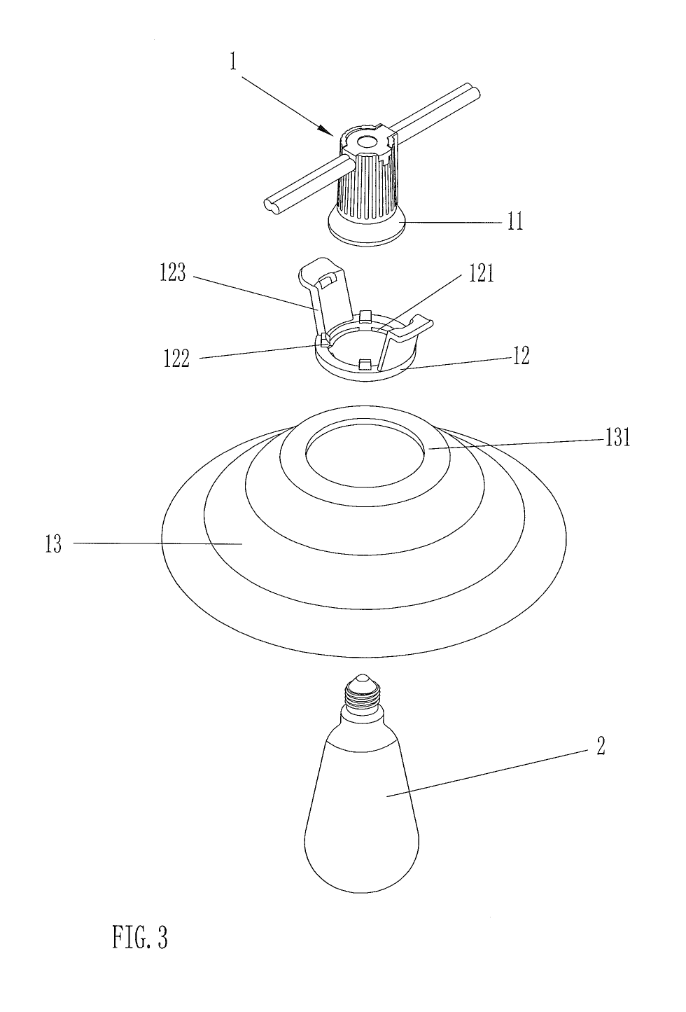

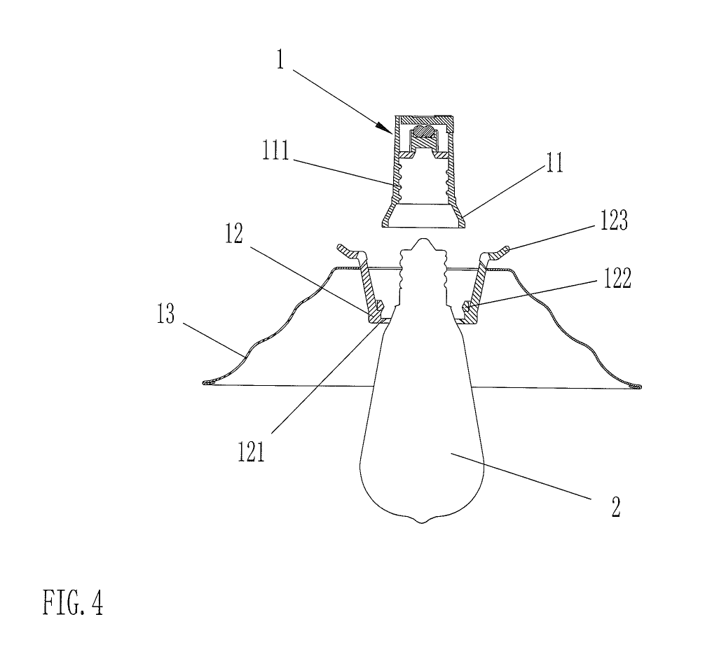

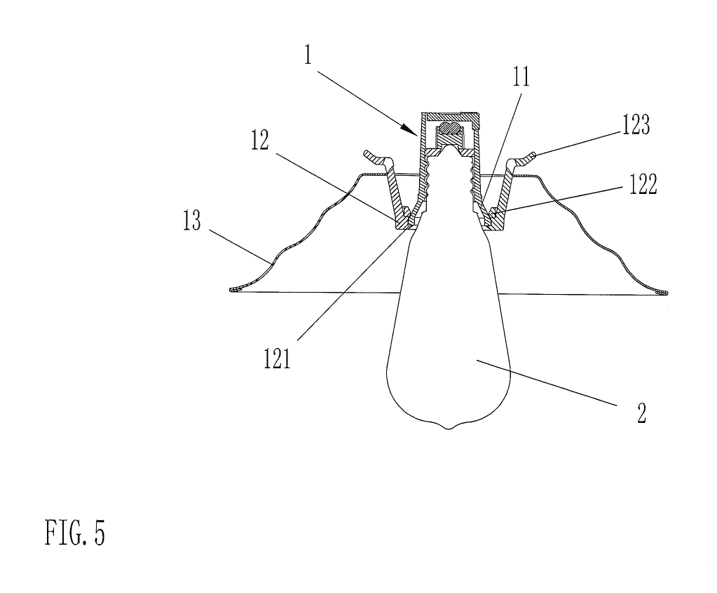

Referring to FIGS. 2 to 5, a fixing structure for a lamp holder according to a preferred embodiment of the present invention comprises:

a locking mount 1 including a conical tab 11 extending outwardly from a bottom of the locking mount 1, and the conical tab 11 having inner threads 111 defined therein to screw with a bulb 2;

a retaining seat 12 including a positioning ring 121, a plurality of retainers 122 arranged around the positioning ring 121, and two oppositely flexible clampers 123 extending outwardly from the positioning ring 121;

a lampshade 13 including a top face 131 for retaining with the two oppositely flexible clampers 123.

In operation, the conical tab 11 of the locking mount 1 is fixed in the positioning ring 121 of the retaining seat 12 and is retained by the plurality of retainers 122, and the retaining seat 12 is placed into the lampshade 13 from the top face 131 so that its two oppositely flexible clampers 123 clamp the locking mount 1 and retain with the top face 131, thereafter the bulb 2 is screwed with the locking mount 1, thus connecting the locking mount 1 with the lampshade 13 easily and removing the locking mount 1 from the lampshade 13 quickly. Preferably, it is unnecessary to fix the locking mount 1 in the retaining seat 12 in advance, as desiring to arrange an electric wire into the locking mount 1.

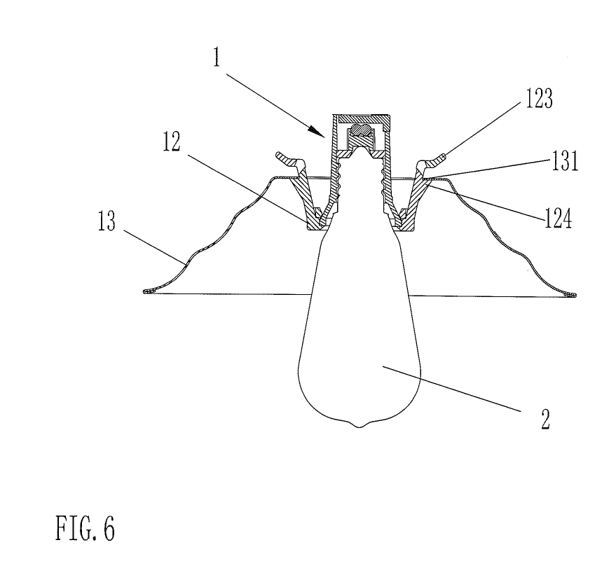

As shown in FIG. 6, a reinforcement extension 124 is formed around a peripheral side of each of the two oppositely flexible clampers 123, such that when the retaining seat 12 is placed into the lampshade 13, the reinforcement extension 124 retains with the lampshade 13 securely.

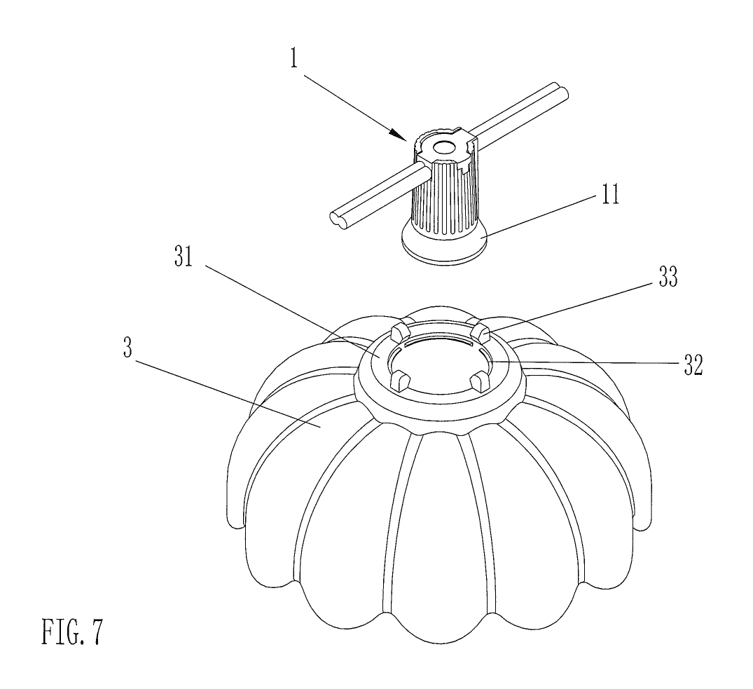

Referring to FIG. 7, in another embodiment, the lampshade 3 has an engaging rib 32 formed around an inner side of the top face 31 thereof and has a plurality of affix protrusions 33 arranged thereon, such that the conical tab 11 of the locking mount 1 is placed into the engaging rib 32 of the lampshade 3 and is retained by the plurality of affix protrusions 33 easily.

While the preferred embodiments of the invention have been set forth for the purpose of disclosure, modifications of the disclosed embodiments of the invention as well as other embodiments thereof may occur to those skilled in the art. The scope of the claims should not be limited by the preferred embodiments set forth in the examples, but should be given the broadest interpretation consistent with the description as a whole.

What is claimed is:

1. A fixing structure for a lamp holder comprising:
a locking mount including a conical tab extending outwardly from a bottom of the locking mount;
a retaining seat including a positioning ring, a plurality of retainers arranged around the positioning ring, and two oppositely flexible clampers extending outwardly from the positioning ring;
a lampshade including a top face for retaining with the two oppositely flexible clampers.

2. The fixing structure for the lamp holder as claimed in claim 1, wherein a reinforcement extension is formed around a peripheral side of each of the two oppositely flexible clampers, such that when the retaining seat is placed into the lampshade, the reinforcement extension retains with the lampshade.

3. The fixing structure for the lamp holder as claimed in claim 1, wherein the lampshade has an engaging rib formed around an inner side of the top face thereof and has a plurality of affix protrusions arranged thereon, such that the conical tab of the locking mount is placed into the engaging rib of the lampshade and is retained by the plurality of affix protrusions.
